(19) United States
(12) Patent Application Publication
(10) Pub. No.: US 2015/0061967 A1
(43) Pub. Date: Mar. 5, 2015

(54) IMAGE ADJUSTING DEVICE AND METHOD FOR PERFORMING IMAGE CALIBRATION USING A PATCH IMAGE

(71) Applicant: SAMSUNG ELECTRONICS CO., LTD., Suwon-si (KR)

(72) Inventors: Ju-yong KIM, Suwon-si (KR); Su-ryun JIN, Suwon-si (KR)

(73) Assignee: SAMSUNG ELECTRONICS CO., LTD., Suwon-si (KR)

(21) Appl. No.: 14/334,101

(22) Filed: Jul. 17, 2014

(30) Foreign Application Priority Data
Sep. 3, 2013 (KR) 10-2013-0105355

(51) Int. Cl. G06F 3/14; G09G 5/10; G09G 5/04

(52) U.S. Cl. CPC G06F 3/1446; G09G 5/04; G09G 5/10; G09G 2320/0233; G09G 2320/0242; G09G 2320/0693
USPC 345/1.3

(57) ABSTRACT

An image adjusting apparatus is provided. The image adjusting apparatus includes: a first interface configured to be connected to a plurality of display apparatuses; a second interface configured to be connected to a calibrator; and a controller configured to generate a plurality of different patch images and provide the generated plurality of different patch images to each of the plurality of display apparatuses through the first interface.

### CROSS-REFERENCE TO RELATED APPLICATIONS

This application claims priority from Korean Patent Application No. 10-2013-0105355, filed in the Korean Intellectual Property Office on Sep. 3, 2013, the disclosure of which is incorporated herein by reference, in its entirety.

### BACKGROUND

1. Technical Field

Methods and apparatuses consistent with the exemplary embodiments relate to an image adjusting apparatus and method for performing image calibration, and a record medium where the method is recorded. More particularly, the exemplary embodiments relate to an image adjusting apparatus and method for performing image adjustment using a patch image displayed on a display apparatus.

2. Description of the Related Art

Even though an identical color should be expressed by color characteristics, electrical characteristics, or optical characteristics of a display apparatus, there a phenomenon may occur where color information moves or brightness changes. Such a phenomenon is called spatial non-uniformity. In general, brightness changes up to 40% in a display apparatus. In order to resolve such spatial non-uniformity, image adjustment is necessary. A user may perform calibration on a display apparatus comprising spatial non-uniformity in order to measure characteristic values such as the chroma, light and shade, contrast and brightness of an image and may adjust the image according to the measurement result.

In general, an image adjusting apparatus which adjusts an image of a plurality of display apparatuses is connected to a calibrator. The calibrator performs a function of measuring characteristic values, that is the chroma, light and shade, contrast and brightness, etc. of an image of a display apparatus and transmitting the measured characteristic values to the image adjusting apparatus. The image adjusting apparatus that received the characteristic values adjusts the characteristic values of the display apparatus.

In the related art, a user was required for operating the image adjusting apparatus and another user was required for measuring the characteristic values with a calibrator were required, in each of a plurality of display apparatuses when performing image adjustment regarding each of a plurality of display apparatuses with one image adjusting apparatus.

In this case, the user who measures the characteristic values with a calibrator had to set an ID value of a display apparatus that performs the calibration, and another user who operates the image adjusting apparatus had to set the same ID value, which caused inconvenience. As a result, the more the number of display apparatuses, the more difficult it was to adjust images.

Therefore, there exists a need for image adjusting apparatuses capable of resolving these problems.

### SUMMARY

The purpose of the exemplary embodiments is to provide an image adjusting apparatus and an image adjusting method for generating a plurality of different patch images, and transmitting the generated plurality of different patch images and performing image adjustment based thereon.

According to an exemplary embodiment, an image adjusting apparatus is provided. The image adjusting apparatus includes: a first interface configured to be connected to a plurality of display apparatuses; a second interface configured to be connected to a calibrator; and a controller configured to generate a plurality of different patch images and provide the generated plurality of different patch images to each of the plurality of display apparatuses through the first interface.

In this case, in response to a patch image being read by the calibrator with each of the plurality of patch images displayed on each of the plurality of display apparatuses, the controller may be configured to identify the display apparatus that displays the read patch image according to a read value, and may be configured to perform image adjustment based on the read value regarding the identified display apparatus.

Furthermore, the image adjusting apparatus may further include a storage configured to store an ID allocated to each of the plurality of display apparatuses.

In this case, the controller may be configured to match the patch image per ID and store the matched patch image in the storage.

In addition, the controller may be configured to detect at least one characteristic value of the display apparatus from the read value regarding the patch image displayed on the identified display apparatus, and may be configured to perform the image adjustment by adjusting the detected characteristic value to a predetermined target value.

In this case, the characteristic value may comprise at least one of brightness, chroma, contrast and light and shade.

In this case, the target value may be a value input by a user.

In addition, the controller may randomly generate a plurality of IDs automatically so that there is no overlapping ID and may allocate the plurality of IDs to each of the plurality of display apparatuses, and store the allocated ID to the storage.

In addition, the controller may randomly generate the plurality of patch images automatically, and randomly match the plurality of patch images to each of the plurality of IDs.

In addition, the plurality of patch images may be images of different colors.

Furthermore, the plurality of patch images may be images having different gray levels.

According to an exemplary embodiment, there is provided an image adjusting method of an image adjusting apparatus, the image adjusting method comprising: providing a plurality of different patch images to each of a plurality of display apparatuses; in response to a calibrator reading a patch image displayed on a display apparatus, with each of the plurality of patch images displayed on each of the plurality of display apparatuses, receiving a read value from the calibrator; identifying a display apparatus where the read patch image is displayed according to the read value; and performing an image adjustment based on the read value regarding the identified display apparatus.

In addition, the performing a calibration may include detecting at least one characteristic value of the display apparatus from a read value regarding a patch image displayed on the identified display apparatus; and performing the image adjustment by adjusting the detected characteristic value to a predetermined target value.

The characteristic value may include at least one of brightness, chroma, contrast, light and shade.

The image adjusting target value may be a value input by a user.

In addition, the image adjusting method may further include automatically generating a plurality of IDs so that there is no overlapping ID; and allocating the plurality of IDs to each of the plurality of display apparatuses and storing the allocated IDs.

In addition, the image adjusting method may further include automatically generating the plurality of patch images in a random manner automatically; and randomly matching the generated plurality of patch images to each of the plurality of IDs. Furthermore, the plurality of patch images may be images of different colors.

The plurality of patch images may be images having different gray levels.

Meanwhile, a non-transitory record medium is provided where a program for performing an image adjusting method is recorded, wherein the image adjusting method includes: providing a plurality of different patch images to each of a plurality of display apparatuses; in response to a calibrator reading a patch image displayed on a display apparatus, with each of the plurality of patch images displayed on each of the plurality of display apparatuses, receiving a read value from the calibrator; identifying a display apparatus where the read patch image is displayed according to the read value; and performing image adjustment based on the read value regarding the identified display apparatus.

According to another exemplary embodiment, there is provided an image adjusting apparatus including: a first interface configured to be connected to a display apparatus; a second interface configured to be connected to a calibrator; and a controller configured to generate a plurality of different patch images and provide the generated plurality of different patch images to each of the plurality of display apparatuses through the first interface.

When a patch image is read by the calibrator with each of the plurality of patch images displayed on each of the plurality of display apparatuses, the controller may identify the display apparatus that displays the read patch image, according to a read value, and perform an image adjustment based on the read value regarding the identified display apparatus.

According to another exemplary embodiment, there is provided a plurality of display apparatuses; a calibrator for detecting a characteristic value of each of the plurality of display apparatuses; and an image adjusting apparatus configured to perform an image adjustment regarding each of the plurality of display apparatuses based on the characteristic value.

Herein, the image adjusting apparatus may be configured to generate a plurality of patch images and provide each patch image to the plurality of display apparatuses, the plurality of display apparatuses may be configured to display each provided patch image, and the image adjusting apparatus, in response to a patch image displayed on a display apparatus being read by the calibrator, may identify a display apparatus that displays the read patch image according to a read value, and perform image adjustment based on the read value regarding the identified display apparatus.

An aspect of an exemplary embodiment may provide an image adjusting apparatus including: a calibrator configured to detect a characteristic value of each of a plurality of display apparatuses; and a controller configured to generate a plurality of different patch images and provide the generated plurality of different patch images to each of the plurality of display apparatuses and to automatically generate a plurality of IDs in a random manner so that there are no overlapping IDs and allocates the plurality of IDs to each of the plurality of display apparatuses; wherein, in response to a patch image being read by the calibrator with each of the plurality of patch images displayed on each of the plurality of display apparatuses, the controller is configured to identify the display apparatus that displays the read patch image according to a read value, and performs an image adjustment based on the read value regarding the identified display apparatus.

The image adjusting apparatus may further include a first interface configured to be connected to the plurality of display apparatuses; and a second interface configured to be connected to the calibrator.

The image adjusting apparatus may further include a storage configured to store the IDs allocated to each of the plurality of display apparatuses, wherein the controller is configured to match the patch image per ID and stores the matched patch image in the storage.

According to the aforementioned various exemplary embodiments, it is possible to perform image adjustment quickly and precisely with a small number of people using patch images, thereby improving a user's convenience, efficiency and economic feasibility of the apparatus.

### BRIEF DESCRIPTION OF THE DRAWINGS

The above and/or other aspects will be more apparent by describing certain exemplary embodiments with reference to the accompanying drawings, in which:

FIG. 1 is a mimetic view of an image adjusting system, according to an exemplary embodiment.

FIG. 2 is a block diagram of an image adjusting apparatus according to an exemplary embodiment.

FIGS. 3 to 6 are views which illustrate a process of operating an image adjusting apparatus, according to an exemplary embodiment.

FIG. 7 is a flowchart of a method of adjusting an image according to an exemplary embodiment.

FIG. 8 is a block diagram of an image adjusting apparatus according to another exemplary embodiment.

FIG. 9 is a flowchart of a method of adjusting an image according to an exemplary embodiment.

FIG. 10 is a mimetic view of an image adjusting system, according to an exemplary embodiment.

### DETAILED DESCRIPTION OF THE EXEMPLARY EMBODIMENTS

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of the exemplary embodiments. However, exemplary embodiments can be practiced without those specifically defined matters. Also, well-known functions or constructions are not described in detail since they would obscure the application with unnecessary detail.

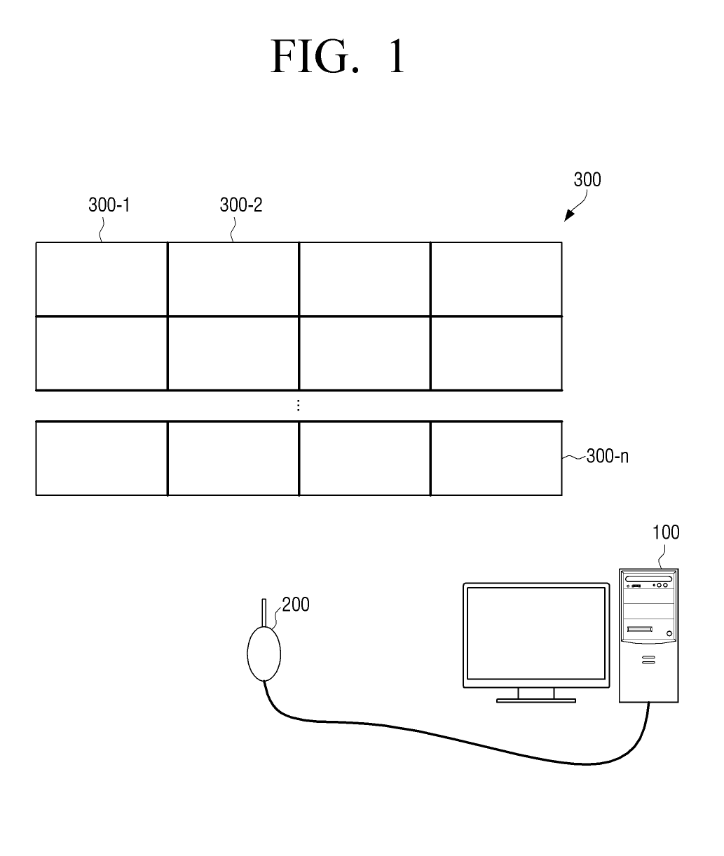

FIG. 1 is a mimetic view of an image adjusting system, according to an exemplary embodiment.

According to FIG. 1, an image adjusting system according to an exemplary embodiment may comprise an image adjusting apparatus 100, calibrator 200, and a plurality of display apparatuses 300.

The image adjusting apparatus 100 may consists of hardware such as a controller, interface, and storage etc., and software that drives the hardware. In response to an image characteristic value being read using a calibrator, the software may perform operations of control command, comparison of mathematical formulas and calculations etc. for performing image adjustment in a plurality of display apparatuses 300.

The calibrator 200 is connected to the image adjusting apparatus 100 according to a wired or wireless communication method. The calibrator 200 may detect a characteristic value of each of the plurality of display apparatuses, and provide the detected characteristic value to the image adjusting apparatus 100. More specifically, the calibrator 200 may physically contact the plurality of display apparatuses 300, read the characteristic values such as the brightness, chroma, brightness, and contrast values of an image, and transmit the corresponding characteristic value to the image adjusting apparatus 100.

The calibrator may be, for example, a spectro photometer or filter chromameter etc. A spectro photometer has an advantage that it is capable of automatically obtaining a color combination value, and thus may be directly used in a color mixing process, and since it is capable of calculating a color value using a spectro intensity distribution of a base light source, it is capable of obtaining a color value under various light source conditions. A filter chromameter consists of simple and inexpensive equipment such as a light source specimen and light detector etc.

A plurality of display apparatuses 300 may consist of a TV such as an LCD or PDP etc., i.e., a gathering of two or more display apparatuses. A plurality of display apparatuses 300 may be connected to the image adjusting apparatus 100 via an interface (not illustrated), and may transceive image signals and control commands. More specifically, for image signals, the plurality of display apparatuses 300 may be connected to the image adjusting apparatus via HDMI (High Definition Multimedia Interface), DVI (Digital Visual Interface), D-SUB etc., while for control commands, the plurality of display apparatuses 300 may be connected to the image adjusting apparatus via a RS232 port or a LAN.

The image adjusting apparatus 100 may generate a plurality of different patch images and provide each patch image to the plurality of display apparatuses 300-1 to 300-n. Accordingly, each display apparatus 300-1 to 300-n may display a patch image provided to itself.

A user may read a patch image displayed on each display apparatus 300-1 to 300-n using a calibrator 200. The calibrator 200 transmits a read value to the image adjusting apparatus 100.

The image adjusting apparatus 100 determines the display apparatus in which the image adjustment has been made using the read value transmitted from the calibrator. For example, in response to the calibrator reading a patch image displayed on a display apparatus 300k located in the kth from among the plurality of display apparatuses, the image adjusting apparatus 100 compares the characteristics of the read patch image and the identification information of the display apparatuses 300-1 to 300-n matched per patch image, and determines that the calibration was made in the kth display apparatus 300-k.

Accordingly, when the kth display apparatus 300-k is identified, the image adjusting apparatus 100 performs image adjustment based on the read value regarding the kth display apparatus 300-k. More specifically, the brightness, chroma, contrast, and light and shade etc. of the corresponding display apparatus 300-k are adjusted to be within a similar range of other surrounding display apparatuses.

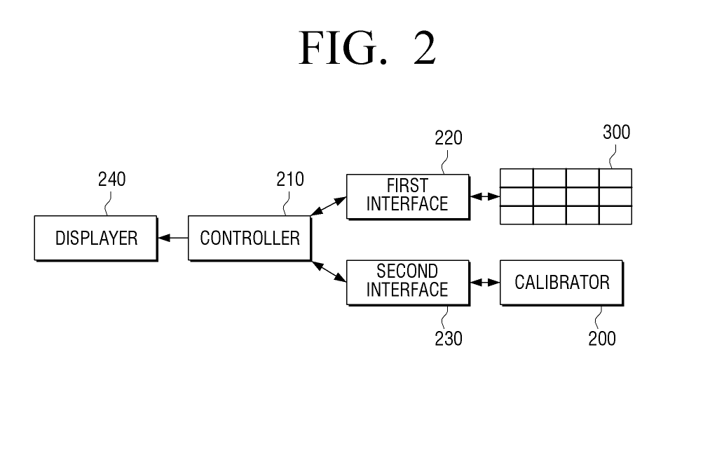

FIG. 2 is a block diagram of an image adjusting apparatus according to another exemplary embodiment.

According to FIG. 2, the image adjusting apparatus 100 may comprise a controller 210, first interface 220, second interface 230 and calibrator 200.

In addition, the image adjusting apparatus 100 may further comprise a displayer 240.

The first interface 220 connects the image adjusting apparatus 100 with a plurality of display apparatuses 300. The first interface 220 may consist of two areas. One area may consist of DVI, HDMI, D-SUB etc., so as to transceive image signals, and the other area may consist of an RS232 port or a LAN, so as to transceive control signals.

The second interface 230 is connected to the image adjusting apparatus 100 and calibrator 200. The second interface 230 may consist of a USB interface, etc.

The controller 210 generates a plurality of different patch images and provides the generated plurality of different patch images to each of a plurality of display apparatuses 300 through the first interface 220.

The plurality of different patch images are generated inside the image adjusting apparatus 100, and are provided to each of the plurality of display apparatuses 300 through the first interface 220, and thus one patch image is displayed on each of the plurality of apparatuses.

In this case, in response to the user selecting the display apparatus to perform calibration, the calibrator 200 contacts the selected display apparatus physically and reads one patch image. According to the read value, the display apparatus where the read patch image is displayed is identified, and image adjustment is performed regarding the identified display apparatus based on the read value.

In this case, the plurality of patch images consist of different colors or different gray levels and thus are identifiable. The patch images may be arranged in the center or outskirts of the screen if it is inside a display apparatus.

In addition, the calibrator 200 may physically contact the display apparatus and read the brightness, chroma, contrast, and light and shade of a display image.

The calibrator 200 may be fixated to one area of the display apparatus. A patch image may be arranged corresponding to the location where the calibrator 200 is fixated. The read characteristic value may be transmitted to the image adjusting apparatus 100 through the second interface 230.

That is, the calibrator 200 is connected to the image adjusting apparatus 100 through the second interface 230, and the patch image read through the calibrator 200 is transmitted to the image adjusting apparatus 100 through the second interface. The controller 210 of the image adjusting apparatus 100 identifies the display apparatus using the patch image characteristic value transmitted through the second interface and transmits the image adjusting command to the plurality of display apparatuses 300 through the first interface 220.

The displayer 240 receives a command from the controller 210 and displays a screen which corresponds to the plurality of display apparatuses. More specifically, the displayer 240 may display a UI comprising a plurality of patch images arranged in the same format and order as the arrangement of the plurality of display apparatuses 300-1 to 300-n.

The displayer 240 may be a monitor such as a general LCD or CRT etc.

For example, assuming that the number of the plurality of display apparatuses is n, the screen of the displayer 240 of the image adjusting apparatus 100 is divided into n areas, and there are formed areas which correspond to each of the plurality of display apparatuses. In this case, if a calibration must be made in the kth display apparatus 300-k as in the aforementioned example, the user may bring the calibrator regarding the patch image displayed on the kth display apparatus 300-k. Accordingly, the image characteristic value read in the kth display apparatus 300-k may be transmitted to the image adjusting apparatus 100.

The controller 210 may check the read value of the patch image, and determine which patch image has been read. Accordingly, it is possible to identify the display apparatus where the corresponding patch image has been allocated.

According to such an exemplary embodiment, in response to there no other user that operates the image adjusting apparatus 100, the controller 210 of the image adjusting apparatus 100 becomes able to automatically adjust the image characteristic value such as the light and shade, brightness and contrast, etc. of the kth display apparatus 300-k. Meanwhile, although not illustrated in FIG. 2, the image adjusting apparatus 100 may further comprise a storage that stores the allocated ID regarding each of the plurality of display apparatuses 300.

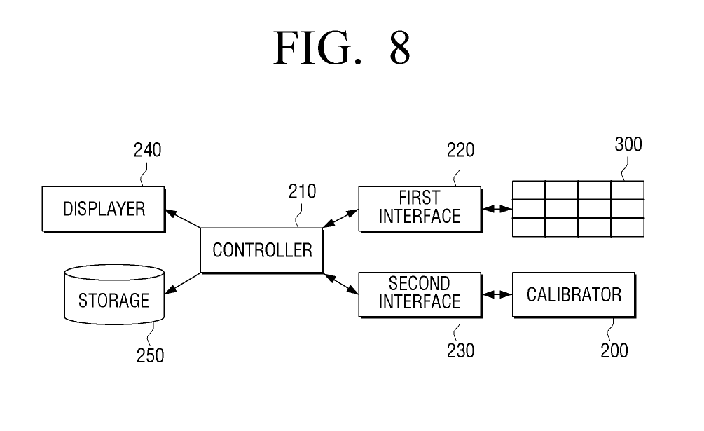

In this case, the controller 210 may match the patch images per ID and store the matched patch image to the storage. More detailed explanation will be made with reference to FIG. 8.

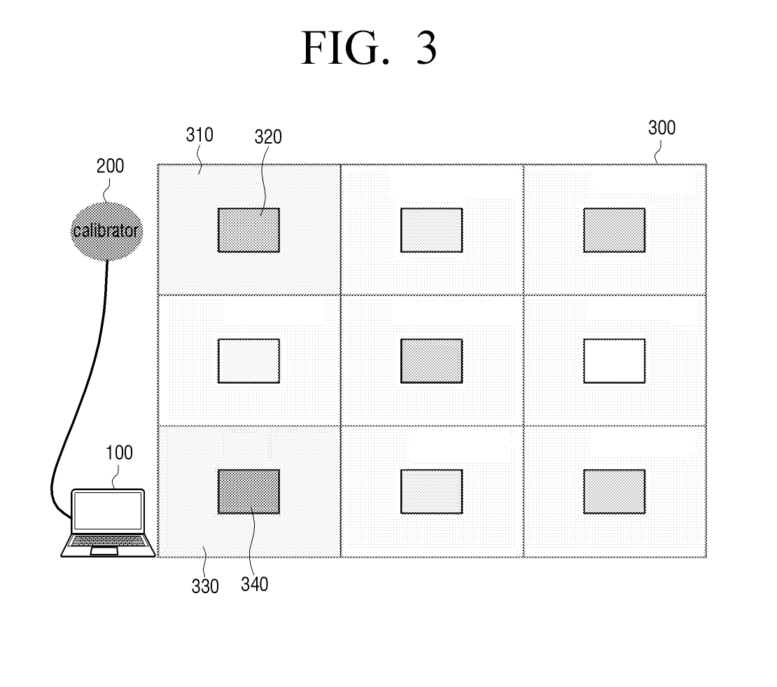

FIGS. 3 to 6 are views illustrating an example of an image adjusting process using an image adjusting apparatus, according to an exemplary embodiment.

More specifically, FIGS. 3 to 6 are views which illustrate an example of an image adjusting process of an image adjusting apparatus in the case where image adjustment is necessary in a first display apparatus 310 and seventh display apparatus 330, from among the plurality of display apparatuses 300.

In FIG. 3, an image adjusting apparatus 100, calibrator 200, and a plurality of display apparatuses 300 are illustrated.

Setting an ID for each of the plurality of display apparatuses 300 may be automatically determined in a random manner in the image adjusting apparatus 100, wherein an ID is allocated to each of the plurality of display apparatuses 300 so that there is no overlapping ID. In addition, the allocated ID may be stored in the storage of the image adjusting apparatus 100.

In such a case, the user inputs an ID directly through an OSD menu. etc. regarding each of the plurality of display apparatuses 300, and there is no need for a process of manually inputting an ID in the image adjusting apparatus 100. Instead, the image adjusting apparatus 100 automatically generates IDs regarding the plurality of display apparatuses 300 and correlates each ID with each of the plurality of display apparatuses 300.

In this case, by automatically allocating an ID to each of the plurality of display apparatuses 300, there is no need for a user driving the image adjusting apparatus 100.

Next, a plurality of patch images may be automatically generated in a random manner in the image adjusting apparatus 100, may be set in different colors or gray levels to be identifiable. Therefore, it becomes possible to avoid overlapping. Each of the plurality of patch images is matched to one of each of the plurality of display apparatuses 300.

More specifically, after the image adjusting apparatus 100 allocates an ID to each of the plurality of display apparatuses 300 without any overlapping, it generates a plurality of different patch images and matches a patch image per each ID. Herein, the patch images are automatically allocated in a random manner such that they have different colors or gray levels from one another. The generated patch images are randomly combined with the IDs.

In this case, it is possible to automatically generate a plurality of patch images in a random manner and match each patch image to an ID. Herein, the ID and the patch image matched thereto may be stored in the storage.

The plurality of patch images generated in the image adjusting apparatus 100 transmit image signals and control signals to the plurality of display apparatuses 300 through the first interface 220. Then, on each display screen of the plurality of display apparatuses 300, there will be displayed a patch image that may identify each display apparatus.

In this case, in the central portion of each of the plurality of display apparatuses, a plurality of different square patch images may be arranged. For example, a patch image may be arranged in the center of the first display apparatus 310 and seventh display apparatus 330.

In addition, the patch images 320, 340 transmitted through the controller 210 of the image processing apparatus 100 may consist of different colors or different gray levels. Besides, other methods may be used besides patch images as long as display apparatuses are identifiable. For example, bar codes or other shapes may be used instead.

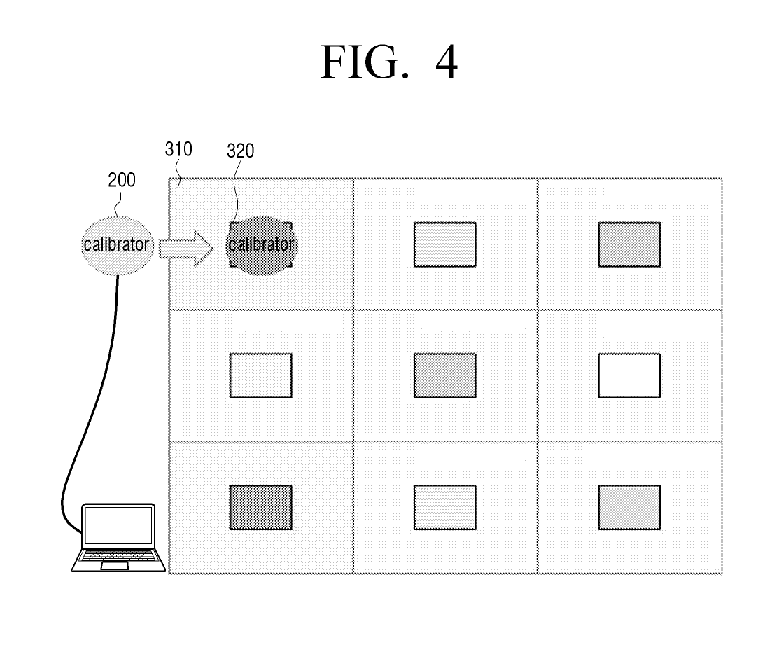

FIG. 4 is a view which illustrates a process of image adjustment of a first display apparatus.

According to FIG. 4, in response to the user physically bringing the calibrator 200 near the center of the first display apparatus using the calibrator 200, not only the characteristic values such as the brightness, chroma, contrast, and light and shade etc. are read, but in addition, the read value regarding the patch image 320 is input through the calibrator and are transmitted to the image adjusting apparatus 100.

In such a case, a user who operates the image adjusting apparatus 100 is not prerequisite????. In response to a user measuring a calibration characteristic value using the calibrator 200, and transmitting the corresponding information to the image adjusting apparatus 100, the image adjusting apparatus 100 may identify in which display apparatus the transmitted patch image was physically measured. In response to the image adjusting apparatus 100 transmitting a calibration command to the plurality of display apparatuses 300 through the first interface 220 based on a automatically predetermined target value which may be set by a user, the processor (not illustrated) of the plurality of displays performs image adjustment of the first display apparatus 310.

Herein, the user using the calibrator 200 may have no difficulty in performing image adjustment even when he/she doesn't know the display apparatus ID and patch image color. That is because, in response to only the user performing physical contact with the calibrator 200 to the display apparatus where the calibration is to be performed, the image adjusting apparatus 100 may automatically transmit the necessary command to the plurality of display apparatuses 300.

The image adjusting apparatus 100 adjusts the characteristic value such as the brightness, chroma, contrast, light and shade etc. of the first display apparatus 310 based on the predetermined image adjustment target value.

In this case, the predetermined image adjustment target value of the image adjusting apparatus 100 may be input and set by the user. For example, the controller 210 may display the UI for setting a target value on the displayer 240. Accordingly, in response to the user setting a target value regarding various characteristic values through the UI, it is possible to store the set target value. In addition, it is possible to set a default value in the controller without receiving an input by the user, to automatically perform image adjustment.

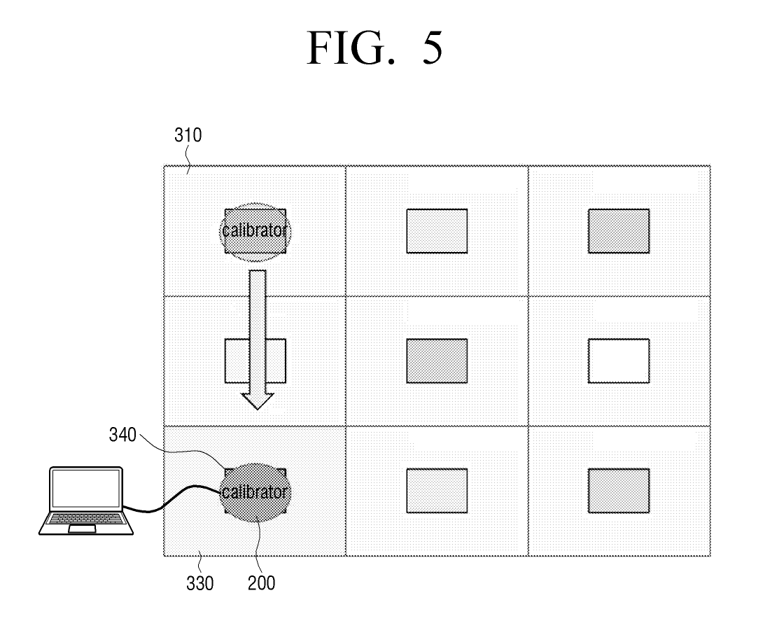

FIG. 5 is a view which illustrates a process of moving to the seventh display apparatus 330 and performing the next calibration after an image adjustment regarding the first display apparatus is completed.

According to FIG. 5, the user performs a calibration regarding the first display apparatus 310 using the calibrator 200, and after discovering the display apparatus 7 (330) for the next calibration, without having to check the ID of the display apparatus 7 (330), in response to only the calibrator being brought to the display apparatus 330, the image adjusting apparatus 100 becomes able to identify the seventh display apparatus 330 through the patch image 340 displayed on the seventh display apparatus 330.

That is, even in response to the user not knowing the ID of the seventh display apparatus 330, nor knowing the color of the patch image 340, there is no problem in performing an image adjustment.

In this case, it is possible to perform image adjustment of the display apparatus 330 with only one user who operates the calibration. Operating the image adjusting apparatus 100 may be performed automatically. Of course, it may be performed manually instead.

In an exemplary embodiment, after performing image adjustment on the first display apparatus 310, the user may select the seventh display apparatus 330 and perform calibration, the user may of course select another display apparatus instead.

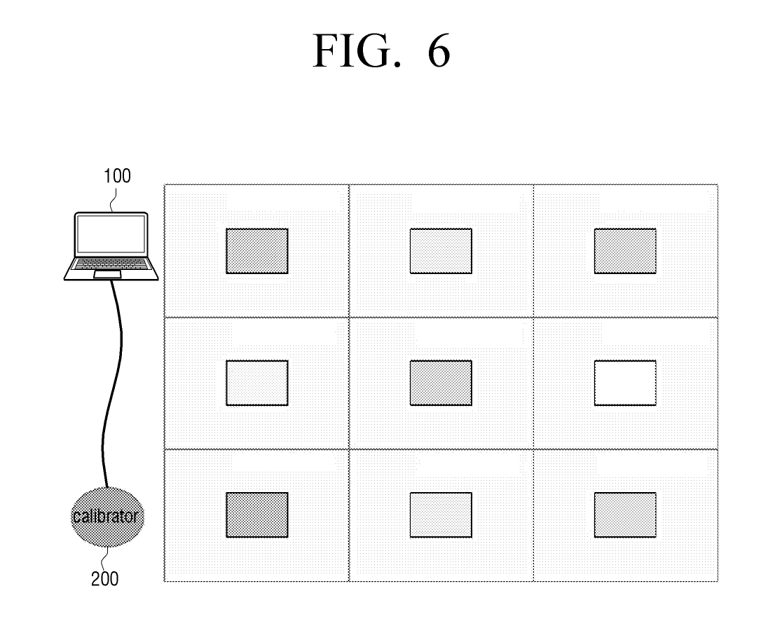

FIG. 6 is a view which illustrates a state where image adjustment of the seventh display apparatus has been completed.

According to FIG. 6, as aforementioned, image adjustment may be performed by only one user operating the calibrator 200. The user becomes able to perform image adjustment quickly, precisely, and with economic feasibility by using a plurality of patch images even if he/she doesn't check the ID regarding each of the plurality of display apparatuses 300 and does not know the color of the patch image.

In addition, FIGS. 3 to 6 illustrate an image adjusting process of the first display apparatus 310 and seventh display apparatus 330, but performing image adjustment to all of the plurality of display apparatuses 300 is also possible.

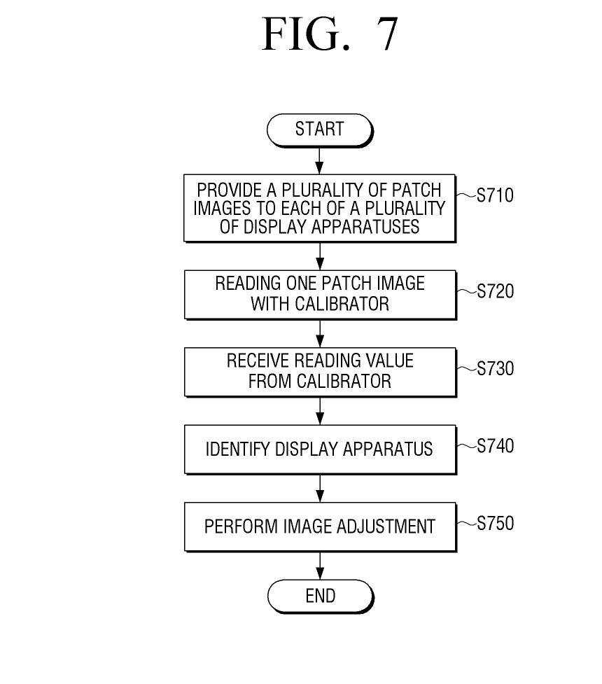

FIG. 7 is a flowchart of a method of adjusting an image according to an exemplary embodiment.

According to FIG. 7, an image adjusting method according to an exemplary embodiment may consist of the following steps. With a plurality of different patch images provided to each of a plurality of display apparatuses 300 (S710) and each of the plurality of patch images displayed on each of the plurality of display apparatuses 300, in response to the calibrator reading a patch image displayed on one display apparatus (S720), a read value is received from the calibrator (S730). A display apparatus displaying the patch image read according to the read value is identified (S740), and image adjustment is performed based on the read value regarding the identified display apparatus (S750).

In this case, in response to performing image adjustment, it is possible to detect a characteristic value from a read value regarding the patch image displayed on the identified display apparatus. It is possible to adjust the detected characteristic value to the predetermined image adjustment target value and perform image adjustment. The characteristic values may comprise brightness, chroma, contrast, light and shade etc. The image adjustment target value may be input by the user, or preset without input by the user to perform image adjustment automatically.

In addition, it is possible to randomly generate a plurality of IDs so that they do not overlap, in an automatic manner so as to facilitate identification of the plurality of display apparatuses 300, and allocate each of the plurality of IDs to each of the plurality of display apparatuses 300. Herein, a plurality of allocated IDs may be stored.

In addition, it is possible to automatically generate a plurality of patch images in a random manner so as to facilitate identification of a plurality of display apparatuses 300, wherein the plurality of patch images have different colors or gray levels so that they do not overlap. These pluralities of patch images may be randomly matched to a plurality of IDs.

In this case, the user does not have to allocate IDs manually. IDs may not only be automatically generated in a random manner, but also a plurality of patch images may also be automatically generated in a random manner to be matched to the IDs. The patch images matching the IDs may be stored. The user then does not have to be aware of detailed matters of the IDs or patch images.

The aforementioned image adjusting method may not only be used in the aforementioned image adjusting apparatus 100 but may be applied to also other apparatuses.

FIG. 8 is a block diagram according to another exemplary embodiment.

According to FIG. 8, the image adjusting apparatus 100 may comprise a controller 210, first interface 220, second interface 230, calibrator 200, and storage 250.

In addition, the image adjusting apparatus 100 may further comprise a displayer 240.

The first interface 220 connects the image adjusting apparatus 100 and the plurality of display apparatuses 300. The first interface 220 may consist of two portions. One portion may consist of DVI, HDMI so as to transceive image signals, and the other portion may consist of RS232, LAN so as to transceive control signals.

The second interface 230 connects the image adjusting apparatus 100 and calibrator 200. The second interface 230 may consist of a USB port, etc.

The controller 210 generates a plurality of different patch images and provides the generated plurality of different patch images to each of the plurality of display apparatuses 300 through the first interface 220.

That is, the plurality of different patch images are generated by the image adjusting apparatus, and one patch image is displayed for each of the plurality of display apparatuses 300 through the first interface 220. The patch images may be arranged in the center of the display apparatus.

In response to the display apparatus for which calibration is to be performed being selected by the user, the calibrator 200 makes physical contact to the selected display apparatus and reads one patch image. The display apparatus where the patch image is read according to the read value is identified and the image adjustment is performed based on the read value regarding the identified display apparatus.

In addition, the calibrator 200 may make a physical contact to the display apparatus and read the chroma, contrast, light and shade etc. of the displayed image.

The calibrator 200 may be fixed to one area of the display apparatus. In the location where the calibrator 200 is fixated, a patch image may be arranged. The read characteristic value may be transmitted to the image adjusting apparatus 100 through the second interface 230.

The storage 250 may store the ID allocated to each of the plurality of display apparatuses 300. ID allocation may be randomly generated in an automatic manner without allowing overlapping. Various types of IDs may be used as long as they are identifiable, such as numbers and special letters, etc.

In addition, after allocating the IDs, the controller 210 may generate a plurality of patch images again. After automatically generating the patch images but not allowing overlapping, the controller 210 may store the plurality of patch images in the storage 250.

In this case, the plurality of patch images have different colors or gray levels and are thus identifiable. The generated patch images are matched to the IDs allocated to the plurality of display apparatuses 300 and then stored in the storage 250. Even in response to the IDs and patch images being randomly matched, it is possible to identify the display apparatus where patch image is read without error using a read patch image, an ID stored in the storage 250, and the patch image matching information. The image adjusting apparatus 100 perform image adjustment based on the read value regarding the identified display apparatus.

The displayer 240 receives a command from the controller 210 and displays a screen which corresponds to the plurality of display apparatuses. The displayer 240 may be a monitor such as an LCD or CRT.

A calibration process is as follows. Assuming that the number of the plurality of display apparatuses is n, the displayer 240 is divided into n areas. Thus an area n corresponds to each of the plurality of display apparatuses. In such a case, in response to calibration being performed in display apparatus 1 (300-k) from among the plurality of display apparatuses, the user may fix the calibrator 200 to the area where the patch area of display apparatus k (300-k) is arranged, read the image characteristic value and transmit the read value to the image adjusting apparatus 100.

Herein, the controller reads each ID of each of the plurality of display apparatuses and the patch image matched per ID in the storage 250. Based on this, the image adjusting apparatus 100 identifies the display apparatus k (300-k), and the controller 210 of the displayer 240 which corresponds to the display apparatus k (300-k) becomes able to automatically adjust the image characteristic value such as the chroma, brightness, contrast etc., of the kth display apparatus 300-k. Based on the read image value, image adjustment regarding the display apparatus k proceeds through the first interface 220. The process may be performed automatically.

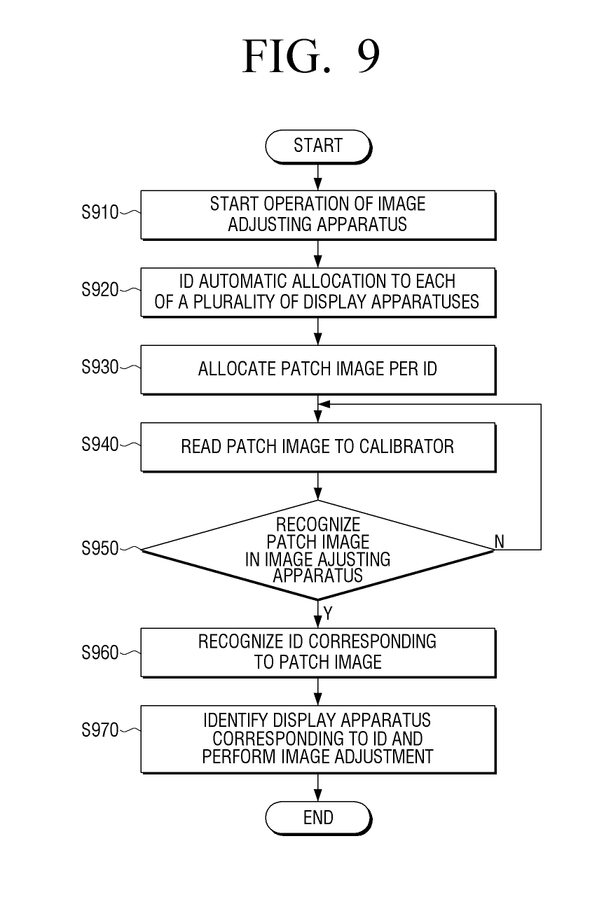

FIG. 9 is a flowchart of an image adjusting method according to an exemplary embodiment.

According to FIG. 9, operation of the image adjusting apparatus begins (S910), and then an ID is automatically allocated to each of the plurality of display apparatuses (S920). Next, a patch image is allocated per ID (S930), and the patch image is read with the calibrator (S940). Next, the display apparatus which corresponds to the allocated ID is identified in order to perform image adjustment (S970). On the other hand, in response to patch image recognition failing in the image adjusting apparatus (S950), there is a wait until the patch image is read by the calibrator.

Operation of the image adjusting apparatus (S910) may be performed as the power of the image adjusting apparatus is turned on. In response to the image adjusting apparatus being inside the main PC, the image adjusting apparatus may be performed in response to the power of the main PC being turned on, and the image adjusting apparatus may be driven as the user explicitly starts operation of the image adjusting apparatus.

Furthermore, herein below is a detailed explanation on the process where each ID is automatically allocated to each of the plurality of display apparatuses 300 (S920). More specifically, in the controller of the image adjusting apparatus 100, an ID which corresponds to each of the plurality of display apparatuses is allocated. The IDs may be allocated manually by the user, or may be automatically allocated by the controller in a random manner in order to correspond to the plurality of display apparatuses 300. In this case, the user does not have to generate a particular ID. The generated ID is stored in the storage of the image adjusting apparatus.

In addition, herein below is detailed explanation on a process where a patch image is allocated per ID (S930). More specifically, in the controller of the image adjusting apparatus 100, a patch image is automatically generated in a random manner to correspond to each of the plurality of display apparatuses 300. In addition, patch images having different colors or gray levels are generated. The generated patch image may be stored in the storage. Herein, IDs which correspond to the plurality of display apparatuses 300 may be matched to the plurality of patch images which correspond thereto and then stored in the storage.

In addition, herein below is a detailed explanation of reading a patch image with the calibrator 200 (S940). The controller of the image adjusting apparatus 100 transmits an image including a plurality of patch images to the plurality of display apparatuses 300 through the first interface. The transmitted image signals and control signals are transmitted to each display apparatus in the processor of the plurality of display apparatuses 300. Each display apparatus displays an image comprising a patch image. In this case, the user may use the calibrator 200 to physically contact the display apparatus to perform calibration.

In addition, regarding the process of recognizing a patch image in an image adjusting apparatus (S950), the patch image read through the calibrator 200 is transmitted to the image adjusting apparatus 100 through the second interface. The transmitted patch image is then read and recognized in the image adjusting apparatus 100.

The controller of the image adjusting apparatus 100 uses the matching information of the ID stored in the storage and the patch image in order to recognize the ID based on the read information (S960), and after identifying the display apparatus using the matching information, transmits the image adjusting command including the matching information to the first interface (S970). An image adjusting command includes a command to perform calibration in accordance with the image adjusting target value predetermined in the storage. The processor of the plurality of display apparatuses 300 performs image adjustment in the display apparatus selected according to the calibration command, including the patching information.

On the other hand, in response to patch image recognition failing in the image adjusting apparatus, there is a wait until the patch image is read. Furthermore, it is possible to add an alarm, etc. to the image adjusting apparatus and embody the alarm to be executed in response to a predetermined period of time passing.

Meanwhile, in the aforementioned exemplary embodiments, it was explained that in a system provided with a plurality of display apparatuses, calibration and image adjustment is made per display apparatus, but such calibration and image adjustment may be made per area in one display apparatus.

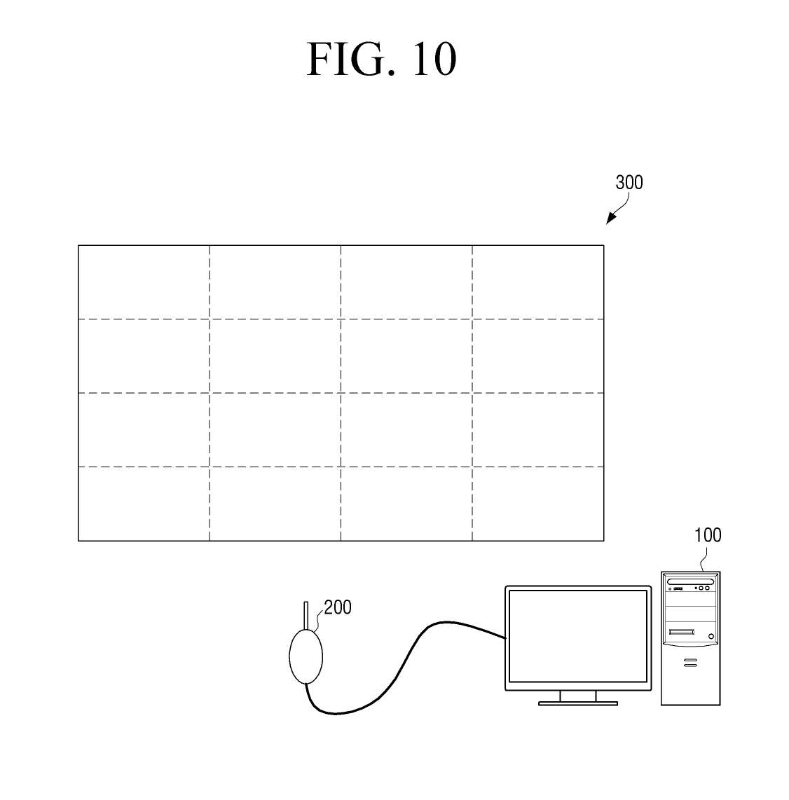

FIG. 10 is a mimetic view for explaining an image adjusting method according to such an exemplary embodiment.

According to FIG. 10, the image adjusting apparatus 100 and calibrator 200 are the same except that there is one display apparatus 300 instead of a plurality of display apparatuses.

The display apparatus 300 is divided into numerous areas, and the display apparatus 300 comprises a first interface connected to the display apparatus, a second interface connected to a calibrator, and a controller configured to generate different patch images and to provide the generated different patch images to the display apparatus.

In response to a plurality of patch images being displayed on each of the divided areas of the display, the controller reads one patch image with the calibrator, transmits the read value to the image adjusting apparatus, and then the image adjusting apparatus is able to perform image adjustment based on the read value. The controller may also perform the functions mentioned hereinabove.

The controller allocates unique identification information per each screen area of the display apparatus 300, and matches a patch image per screen area. Accordingly, when a patch image is read, it is possible to automatically identify which screen area displays that patch image. The controller may automatically perform image adjustment so that the screen characteristic value of the identified area corresponds to the screen characteristic value of the surrounding areas. The image adjustment method and calibration method were already explained in the aforementioned exemplary embodiments, and thus repeated explanation is omitted.

According to another exemplary embodiment, there is provided an image adjusting system including a plurality of display apparatuses, calibrator for detecting a characteristic value of each of the plurality of apparatuses, and an image adjusting apparatus capable of performing image adjustment regarding each of the plurality of display apparatuses based on the characteristic value, wherein the image adjusting apparatus generates a plurality of different patch images and provides each patch image to the plurality of display apparatuses, the plurality of display apparatuses each displays the provided patch image, and in response to a patch image displayed on one display apparatus being read by the calibrator, the image adjusting apparatus identifies the display apparatus that displays the patch image according to the read value, and performs image adjustment based on the read value regarding the display apparatus.

Meanwhile, an image adjusting method of an image adjusting apparatus according to the aforementioned various exemplary embodiments may be embodied in a program and be provided in an image adjusting apparatus.

More specifically, there may be provided a non-transitory computer readable storage medium where there is stored a program comprising a step of providing each of a plurality of different patch images to each of a plurality of display apparatuses, a step of receiving a read value from the calibrator in response to a calibrator reading a patch image displayed on one display apparatus with each of the plurality of patch images displayed on each of the plurality of display apparatuses a step of identifying a display apparatus which displays the patch image read according to the read value, and a step of performing image adjustment based on the read value regarding the identified display apparatus.

A non-transitory computer readable medium refers to a computer readable storage medium where data can be stored semi-permanently and not a medium that stores data for a short period of time such as a resister, cache, and memory etc. More specifically, the aforementioned various applications or programs may be stored in and provided by non-transitory computer readable medium such as CD, DVD, hard disk, Blue-ray Disc™, USB, memory card, and ROM etc.

Although a few exemplary embodiments have been shown and described, it would be appreciated by those skilled in the art that changes may be made to these exemplary embodiments without departing from the principles and spirit of the invention, the scope of which is defined in the claims and their equivalents.

What is claimed is:

1. An image adjusting apparatus comprising:
a first interface configured to be connected to a plurality of display apparatuses;
a second interface configured to be connected to a calibrator; and
a controller configured to generate a plurality of different patch images and provide the generated plurality of different patch images to each of the plurality of display apparatuses through the first interface,
wherein, in response to a patch image being read by the calibrator with each of the plurality of patch images displayed on each of the plurality of display apparatuses, the controller is configured to identify the display apparatus that displays the read patch image according to a read value, and performs an image adjustment based on the read value regarding the identified display apparatus.

2. The image adjusting apparatus according to claim 1,
further comprising a storage configured to store an ID allocated to each of the plurality of display apparatuses,
wherein the controller is configured to match the patch image per ID and stores the matched patch image in the storage.

3. The image adjusting apparatus according to claim 1,
wherein the controller is configured to detect at least one characteristic value of the display apparatus from the read value regarding the patch image displayed on the identified display apparatus, and is configured to perform the image adjustment by adjusting the detected characteristic value to a predetermined target value, and
the characteristic value comprises at least one of brightness, chroma, contrast, light and shade.

4. The image adjusting apparatus according to claim 3,
wherein the target value is a value input by a user.

5. The image adjusting apparatus according to claim 2,
wherein the controller is configured to automatically generate a plurality of IDs in a random manner so that there are no overlapping IDs and allocates the plurality of IDs to each of the plurality of display apparatuses, and stores the allocated IDs to the storage.

6. The image adjusting apparatus according to claim 5,
wherein the controller automatically generates the plurality of patch images in a random manner, and randomly matches the plurality of patch images to each of the plurality of IDs.

7. The image adjusting apparatus according to claim 1,
wherein the plurality of patch images are images of different colors.

8. The image adjusting apparatus according to claim 1,
wherein the plurality of patch images are images having different gray levels.

9. An image adjusting method of an image adjusting apparatus, the image adjusting method comprising:
providing a plurality of different patch images to each of a plurality of display apparatuses;
in response to a calibrator reading a patch image displayed on a display apparatus, with each of the plurality of patch images displayed on each of the plurality of display apparatuses, receiving a read value from the calibrator;
identifying a display apparatus where the read patch image is displayed according to the read value; and
performing an image adjustment based on the read value regarding the identified display apparatus.

10. The image adjusting method according to claim 9,
wherein the performing a calibration comprises:
detecting at least one characteristic value of the display apparatus from a read value regarding a patch image displayed on the identified display apparatus; and
performing the image adjustment by adjusting the detected characteristic value to a predetermined target value;
wherein the characteristic value comprises at least one of brightness, chroma, contrast, light and shade.

11. The image adjusting method according to claim 10,
wherein the target value is a value input by a user.

12. The image adjusting method according to claim 9,
further comprising automatically generating a plurality of IDs so that there is no overlapping; and
allocating the plurality of generated IDs to each of the plurality of display apparatuses and storing the allocated ID.

13. The image adjusting method according to claim 12,
further comprising automatically generating the plurality of patch images in a random manner; and
randomly matching the generated plurality of patch images to each of the plurality of IDs.

14. The image adjusting method according to claim 9,
wherein the plurality of patch images are images of different colors.

15. The image adjusting method according to claim 9,
wherein the plurality of patch images are images having different gray levels.

16. A non-transitory record storage medium where a program for performing an image adjusting method is recorded,
wherein the image adjusting method comprises:
providing a plurality of different patch images to each of a plurality of display apparatuses;
receiving a read value from the calibrator in response to a calibrator reading a patch image displayed on a display apparatus, with each of the plurality of patch images displayed on each of the plurality of display apparatuses;
identifying a display apparatus where the read patch image is displayed according to the read value; and
performing an image adjustment based on the read value regarding the identified display apparatus.

17. An image adjusting apparatus comprising:
a first interface configured to be connected to a display apparatus;
a second interface configured to be connected to a calibrator; and
a controller configured to generate a plurality of different patch images and provide the generated plurality of different patch images to each of the plurality of display apparatuses through the first interface,
wherein the controller identifies the display apparatus that displays the read patch image according to a read value in response to a patch image being read by the calibrator with each of the plurality of patch images displayed on each of the plurality of display apparatuses, and performs an image adjustment based on the read value regarding the identified display apparatus.

18. An image adjusting system comprising:
a plurality of display apparatuses;
a calibrator configured to detect a characteristic value of each of the plurality of display apparatuses; and
an image adjusting apparatus configured to perform an image adjustment regarding each of the plurality of display apparatuses based on the characteristic value,
wherein the image adjusting apparatus generates a plurality of patch images and provides each patch image to the plurality of display apparatuses,
the plurality of display apparatuses display each provided patch image, and
the image adjusting apparatus identifies a display apparatus that displays the read patch image according to a read value in response to a patch image displayed on a display apparatus being read by the calibrator, and performs an image adjustment based on the read value regarding the identified display apparatus.

19. An image adjusting apparatus comprising:
a calibrator configured to detect a characteristic value of each of a plurality of display apparatuses; and
a controller configured to generate a plurality of different patch images and provide the generated plurality of different patch images to each of the plurality of display apparatuses and to automatically generate a plurality of IDs in a random manner so that there are no overlapping IDs and allocates the plurality of IDs to each of the plurality of display apparatuses;
wherein, in response to a patch image being read by the calibrator with each of the plurality of patch images displayed on each of the plurality of display apparatuses, the controller is configured to identify the display apparatus that displays the read patch image according to a read value, and performs an image adjustment based on the read value regarding the identified display apparatus.

20. The image adjusting apparatus of claim 19, further comprising a first interface configured to be connected to the plurality of display apparatuses; and
a second interface configured to be connected to the calibrator.

21. The image adjusting apparatus of claim 19, further comprising a storage configured to store the IDs allocated to each of the plurality of display apparatuses,
wherein the controller is configured to match the patch image per ID and stores the matched patch image in the storage.
